(19) United States
(12) Patent Application Publication
(10) Pub. No.: US 2026/0071736 A1
(43) Pub. Date: Mar. 12, 2026

(54) RECESSED LUMINAIRE WITH HIDDEN SELECTABLE SWITCH THAT IS ACCESSIBLE VIA ATTACHMENT MECHANISM WITHOUT REMOVAL OF RECESSED LUMINAIRE FROM CEILING OR OTHER STRUCTURE

(71) Applicant: David Sherman, Niagra on the Lake (CA)

(72) Inventor: David Sherman, Niagra on the Lake (CA)

(21) Appl. No.: 19/315,966

(22) Filed: Sep. 2, 2025

Related U.S. Application Data
(60) Provisional application No. 63/692,201, filed on Sep. 9, 2024.

(51) Int. Cl. F21V 17/08; F21S 8/02; F21V 23/04; F21Y 115/10; H05B 45/20

(52) U.S. Cl. CPC F21V 17/08; F21S 8/026; F21V 23/04; H05B 45/20; F21Y 2115/10

(57) ABSTRACT

A luminaire comprising a housing mountable to a building structure, a trim assembly detachably connected to the housing via at least one connection mechanism, and at least one user-accessible switch mounted on or within the housing. The connection mechanism may include a hinge, friction clips, or magnets, allowing the trim assembly to be opened or removed without detaching the housing from the building structure, thus providing access to the switch. The switch may control light attributes including correlated color temperature and wattage. The housing may be attached to an electrical junction box, a recessed lighting fixture, or directly to a ceiling. In some implementations, users can adjust luminaire settings without requiring tools or removing the entire fixture from its mounting surface, thereby providing improved accessibility while maintaining pleasing aesthetic appearance.

### TECHNICAL FIELD

Embodiments set forth here generally relate to recessed luminaires. In particular, the embodiments include selected switches, such as, but not limited to, correlated color temperature switch (“SCCT”) to alter the correlated color temperature and/or a variable wattage switch (“SWAT”) to alter the wattage flowing from a power source to the LEDs. In some implementations, a selectable switch is hidden after installation but can be accessed without removal of the luminaire from a ceiling or other structure to which the luminaire is attached.

### BACKGROUND

Consumers and/or electricians often employ recessed luminaires with integrated switches such as, but not limited to, a SCCT and/or a SWAT. However, the switches are typically located on a part of the luminaire that is behind a structural element (e.g., ceiling, wall, etc.) after installation and thus not easily or readily accessible for adjusting. As a result, a user may be required to choose the setting(s) of such switches prior to installation, with the expectation that the switches may not be adjusted thereafter without risking damaging their ceiling, wall, etc. For example, to select a new setting for a switch after installation, the user may be required to remove the installed luminaire from a structural element and make their new selection, then re-install the luminaire back onto the structural element. This may be cumbersome and difficult for a typical user who may not be comfortable engaging wiring behind their walls or ceilings. Instead, users may outsource such adjustments to an electrician, ultimately delaying the switching and expending excessive energy and other resources to remove and re-install the luminaire.

Thus, in view of the above, there is a long-felt need in the industry to address the deficiencies and inadequacies. Further limitations and disadvantages of conventional and traditional approaches will become apparent to one of skill in the art through comparison of described systems, methods, and apparatuses with some aspects of the present disclosure, as set forth in the remainder of the present application and with reference to the drawings.

### SUMMARY

A luminaire with LED(s) and/or other light source(s), with user selectable switches. to install onto a structural element, which said structural element can be, but not limited to, a ceiling, a wall, a recessed lighting fixture housing, or a building's electrical outlet box, as shown in and/or described in connection with the figures.

In some implementations, a luminaire is set forth as comprising a plurality of friction retrofit clips or torsion spring retrofit clips or new construction spring clips of varying designs, sizes, shapes, thicknesses, and materials; a plurality of connecting posts; a body of varying designs, sizes, shapes, thicknesses, and materials; a luminaire trim of varying designs, sizes, shapes, thicknesses, and materials; a diffuser lens of varying designs, sizes, shapes, thicknesses, and materials; a plurality of holes; an LED driver; a lamp holder or other electrical components; a socket adapter of varying designs, sizes, shapes thicknesses, and materials; a fixed or removable junction box of varying designs, sizes, shapes, thicknesses, and materials; a plurality of wire connectors; and a complete luminaire of varying designs, sizes, shapes, thicknesses, and materials; if a removable or fixed junction box is embodied it may contain a dedicated section to allow for the connection of wiring and that will hold a plurality of connection wiring and output wires. It may also contain one or a plurality of an LED driver, a transformer, a WIFI module, or other electrical components.

In some implementations, a junction box may be removable or fixed in position on the body or complete fixture. In some implementations, a junction box includes a predefined area to attach a plurality of wires. In some implementations, a junction box is configured to secure one or more of an LED driver, a WIFI module, or other electrical components. In some implementations, wire connectors attach the building's electrical supply wires to the wires in the junction box or to the input wires of a complete luminaire.

In some implementations, a socket adapter replaces a light bulb in a recessed lighting fixture housing.

In some implementations, new construction spring clips squeeze ceiling material placed between the new construction spring clips and extremities of a luminaire trim or housing. In some implementations, friction retrofit clips secure the luminaire inside a recessed lighting fixture housing. In some implementations, torsion spring retrofit clips secure the luminaire inside a recessed lighting fixture housing. In some implementations, the luminaire is installed onto a building's electrical outlet box. In some implementations, the luminaire is installed onto a ceiling or wall. In some implementations, the luminaire is installed onto a recessed lighting fixture housing. In some implementations a diffuser lens is attached to a luminaire's trim and such trim is attached by way of a hinge to the luminaire's body. In some implementations a diffuser lens is attached to a luminaire's trim and such trim is attached by way of a plurality of friction fit clips to the luminaire's body. In some implementations a diffuser lens is attached to a luminaire's trim and such trim is attached by way of a plurality of magnets to the luminaire's body.

These features and advantages of the present disclosure may be appreciated by reviewing the following description of the present disclosure, along with the accompanying figures wherein like reference numerals refer to like parts.

The above description is provided as an overview of some implementations of the present disclosure. Further description of those implementations, and other implementations, are described in more detail below.

Other implementations may include a method for manufacturing any of the luminaires discussed herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates a view of a flush mount luminaire with a hinged trim with a diffuser lens, to attach to a building's electrical box, in accordance with at least one embodiment.

FIG. 2 illustrates a view of a recessed luminaire with a hinged trim with a diffuser lens to attach to recessed lighting fixture housing using torsion spring retrofit clips, in accordance with at least one embodiment.

FIG. 3 illustrates a view of a recessed luminaire with a hinged trim with a diffuser lens, to attach to recessed lighting fixture housing using friction retrofit clips, in accordance with at least one embodiment.

FIG. 4A illustrates a view of a recessed luminaire with a hinged trim with a diffuser lens and a removeable junction box, to attach to a ceiling or a wall using new construction spring clips, in accordance with at least one embodiment.

FIG. 4B illustrates a view of a recessed luminaire with a hinged trim with a diffuser lens and a fixed junction box, to attach to a ceiling or a wall, using new construction spring clips, in accordance with at least one embodiment.

FIG. 5 illustrates a view of a flush mount luminaire with a trim with friction clips and a diffuser lens, to attach to a building's electrical box, in accordance with at least one embodiment.

FIG. 6 illustrates a view of a flush mount luminaire with a trim, with magnets and a diffuser lens to attach to a building's electrical box, in accordance with at least one embodiment.

FIG. 7A illustrates a view of a recessed luminaire with a trim with friction clips and a diffuser lens to attach to recessed lighting fixture housing using torsion spring retrofit clips, in accordance with at least one embodiment.

FIG. 7B illustrates a view of a recessed luminaire with a trim with friction clips and a diffuser lens to attach to recessed lighting fixture housing using friction fit retrofit clips, in accordance with at least one embodiment.

FIG. 7C illustrates a view of a recessed luminaire with a trim with magnets and a diffuser lens to attach to recessed lighting fixture housing using torsion spring retrofit clips, in accordance with at least one embodiment.

FIG. 7D illustrates a view of a recessed luminaire with a trim with a diffuser lens and magnets to attach to recessed lighting fixture housing using friction fit retrofit clips, in accordance with at least one embodiment.

FIG. 8A illustrates a view of a recessed luminaire with a trim with friction clips, and a diffuser lens; and a removeable junction box, to attach to a ceiling or wall using new construction spring clips, in accordance with at least one embodiment.

FIG. 8B illustrates a view of a recessed luminaire with a trim with friction clips, and a diffuser lens; and a fixed junction box, to attach to a ceiling or wall using new construction spring clips, in accordance with at least one embodiment.

FIG. 8C illustrates a view of a recessed luminaire with a trim with magnets and a diffuser lens; and a removeable junction box, to attach to a ceiling or wall using new construction spring clips, in accordance with at least one embodiment.

FIG. 8D illustrates a view of a recessed luminaire with a trim with magnets and a diffuser lens; and a fixed junction box, to attach to a ceiling or wall using new construction spring clips, in accordance with at least one embodiment.

FIG. 9 illustrates a view of a flush mount luminaire with a hinged trim with a diffuser lens and a push to open mechanism, to attach to a building's electrical box, in accordance with at least one embodiment.

FIG. 10A illustrates a view of a recessed luminaire with a hinged trim with a diffuser lens and a push to open mechanism, to attach to recessed lighting fixture housing using torsion spring retrofit clips, in accordance with at least one embodiment.

FIG. 10B illustrates a view of a recessed luminaire with a hinged trim with a diffuser lens and a push to open mechanism, to attach to recessed lighting fixture housing using friction retrofit clips, in accordance with at least one embodiment.

FIG. 10C illustrates a view of a recessed luminaire with a hinged trim with a diffuser lens, a removeable junction box and a push to open mechanism, to attach to a ceiling or a wall using new construction spring clips, in accordance with at least one embodiment.

FIG. 10D illustrates a view of a recessed luminaire with a hinged trim with a diffuser lens, a fixed junction box and a push to open mechanism, to attach to a ceiling or a wall, using new construction spring clips, in accordance with at least one embodiment.

### DETAILED DESCRIPTION

The present disclosure may be understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented, and the needs of a particular application may yield multiple alternative and suitable approaches to implement the functionality of any detail described herein. Therefore, any approach may extend beyond certain implementation choices in the following embodiments.

References to “one embodiment,” “at least one embodiment,” “an embodiment,” “one example,” “an example,” “for example,” “implementations,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” or “some implementations” does not necessarily refer to the same embodiment.

Methods herein may be implemented by performing or completing manually, automatically, or a combination thereof, selected steps or tasks. The term “method” refers to manners, means, techniques, and procedures for accomplishing a given task including, but not limited to, those manners, means, techniques, and procedures either known to or readily developed from known manners, means, techniques, and procedures by practitioners of the art to which any implementations belongs. The descriptions, examples, methods, and materials presented in the claims and the specification are not to be construed as limiting but rather as illustrative only. Those skilled in the art will envision many other possible variations within the scope of the technology described herein.

No language in the specification should be construed as indicating any non-claimed element as essential to the practice of any implementation. For simplification purposes, the figures show SCCT and SWAT switches, but other types of switches may be included. It will be apparent to those skilled in the art that various modifications and variations can be made to any implementations without departing from the spirit and scope of any implementation. There is no intention to limit any implementation to the specific form or forms enclosed. On the contrary, the intention is to cover all modifications, alternative constructions, and equivalents falling within the spirit and scope of any implementation, as defined in the appended claims. Thus, it is intended that any implementation covers the modifications and variations, provided they are within the scope of any appended claims and/or their equivalents.

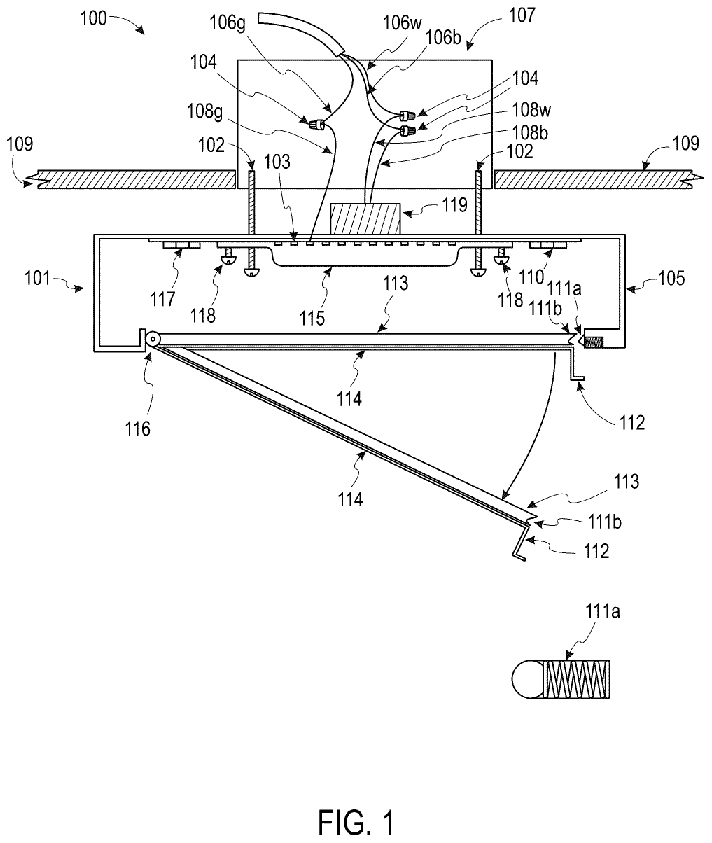

FIG. 1 illustrates a view 100 of a flush mount luminaire with a hinged trim to attach to a building's electrical box, in accordance with at least one embodiment. FIG. 1 depicts a complete flush mount luminaire 101, a plurality of junction box mounting screws 102, an LED printed circuit board assembly (PCBA) 103, a plurality of wire connectors 104, a luminaire housing 105, a building's power wires 106b & 106g & 106w, a building's electrical junction box 107, a luminaire's input wire's 108b & 108g & 108w, wall or ceiling material 109, a switch (SWAT) 110, a housing closing element 111a, a trim closing element 111b, a finger pull 112, a luminaire trim 113, a diffuser lens 114, a protective cover 115, a hinge 116, a switch (SCCT) 117, a plurality of protective cover screws 118, and an LED driver 119.

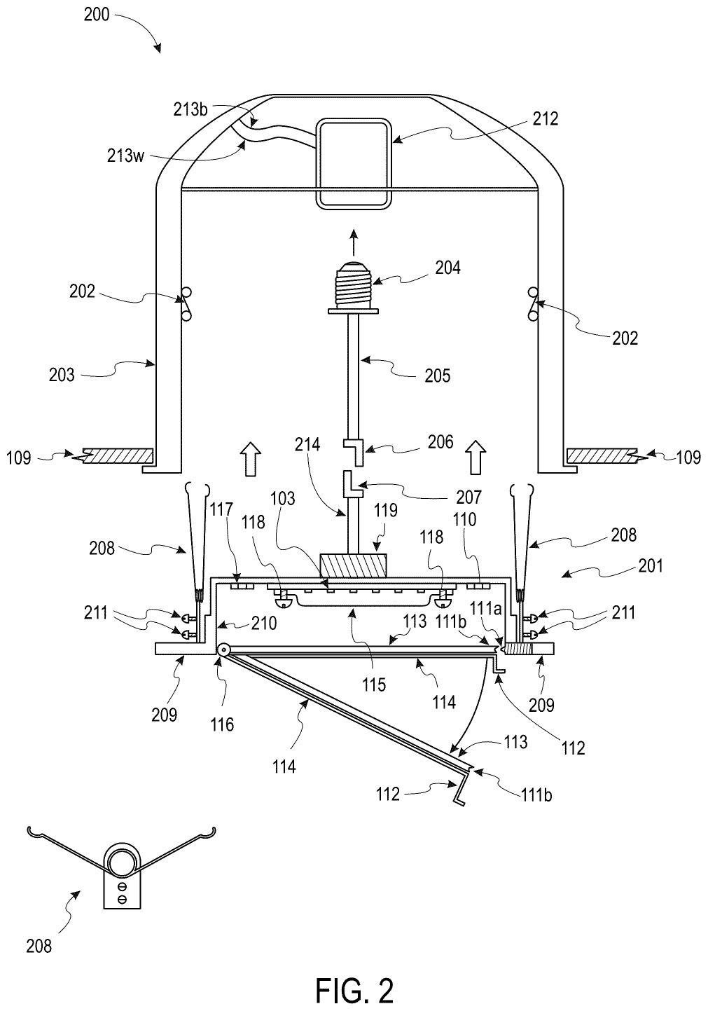

FIG. 2 illustrates a view 200 of a recessed luminaire with a hinged trim to attach to a recessed lighting fixture housing using torsion spring retrofit clips, in accordance with at least one embodiment. FIG. 2 depicts an LED printed circuit board assembly (PCBA) 103, wall or ceiling material 109, a switch (SWAT) 110, a housing closing element 111a, a trim closing element 111b, a finger pull 112, a luminaire trim 113, a diffuser lens 114, a protective cover 115, a hinge 116, a switch (SCCT) 117, a plurality of protective cover screws 118, an LED driver 119, a complete luminaire 201, a plurality of receptacle tabs attached to the inside of a recessed lighting fixture's housing 202, a recessed lighting fixture housing 203, a socket adapter 204, socket adapter output wires 205, a male luminaire disconnect 206, a female luminaire disconnect 207, a plurality of torsion spring retrofit clips 208, a luminaire lip 209, a luminaire housing 210, a plurality of torsion spring attachment screws 211, a lamp holder 212, a recessed lighting fixture's output electrical wires 213b & 213w and an LED driver input wires 214.

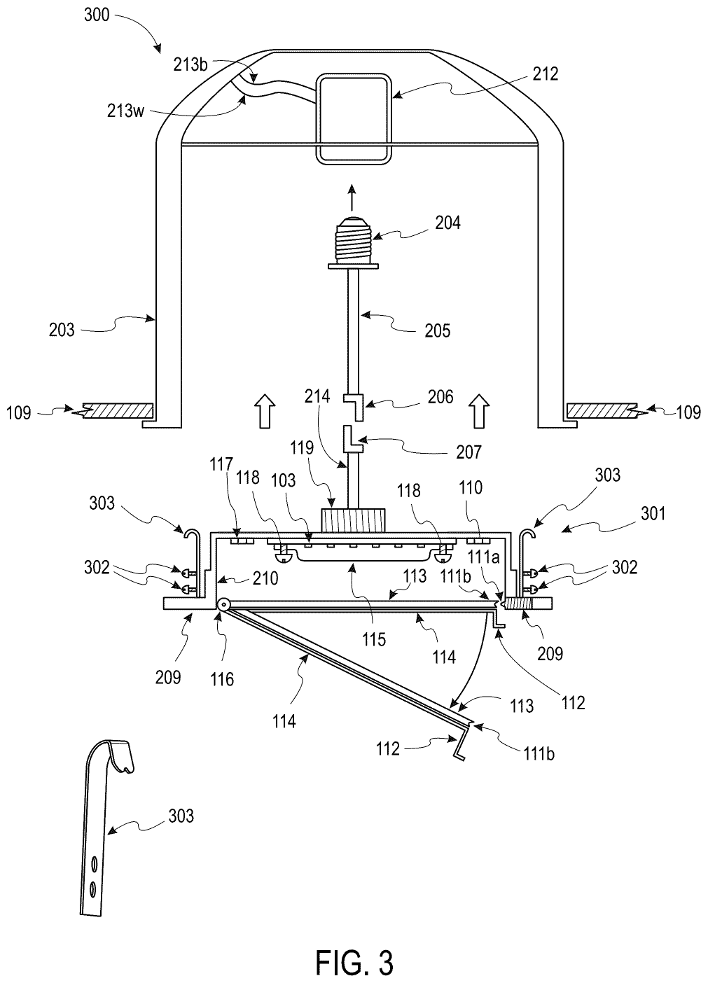

FIG. 3 illustrates a view 300 of a recessed luminaire with a hinged trim to attach to a recessed lighting fixture housing using friction fit retrofit clips, in accordance with at least one embodiment. FIG. 3 depicts an LED printed circuit board assembly (PCBA) 103, wall or ceiling material 109, a switch (SWAT) 110, a housing closing element 111a, a trim closing element 111b, a finger pull 112, a luminaire trim 113, a diffuser lens 114, a protective cover 115, a hinge 116, a switch (SCCT) 117, a plurality of protective cover screws 118, an LED driver 119, a recessed lighting fixture housing 203, a socket adapter 204, socket adapter output wires 205, male luminaire disconnect 206, female luminaire disconnect 207, a luminaire lip 209, a luminaire housing 210, a lamp holder 212, a recessed lighting fixture's output electrical wires 213b & 213w, a complete recessed luminaire 301, a plurality of friction fit retrofit clip attachment screws 302, and a plurality of friction fit retrofit clips 303.

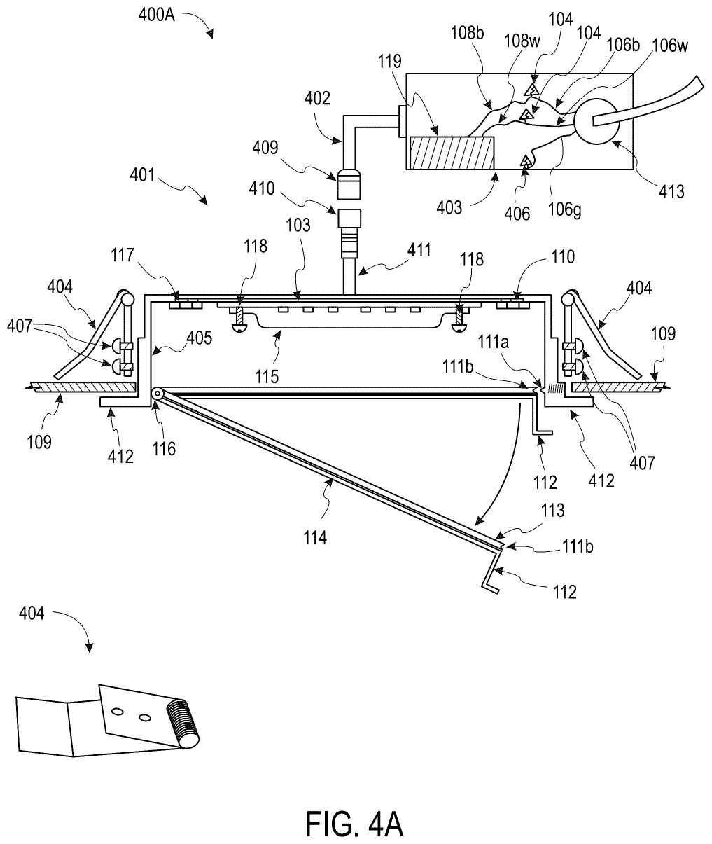

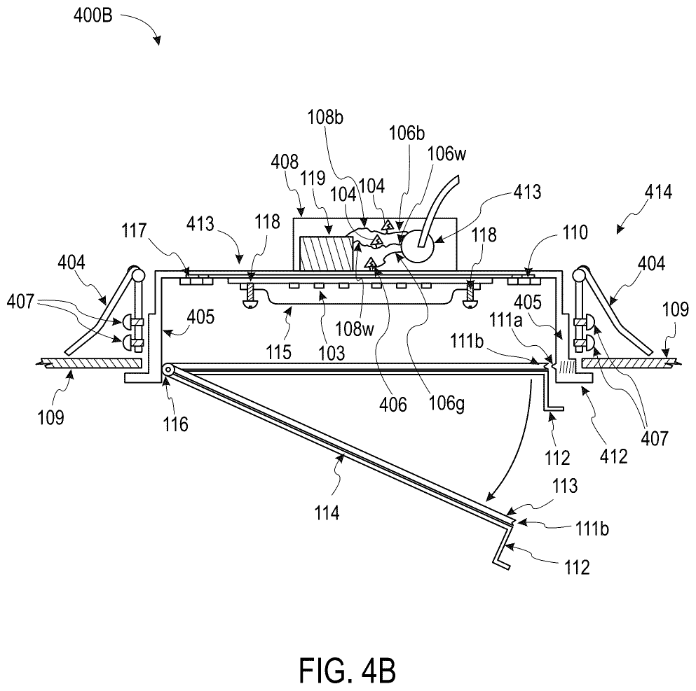

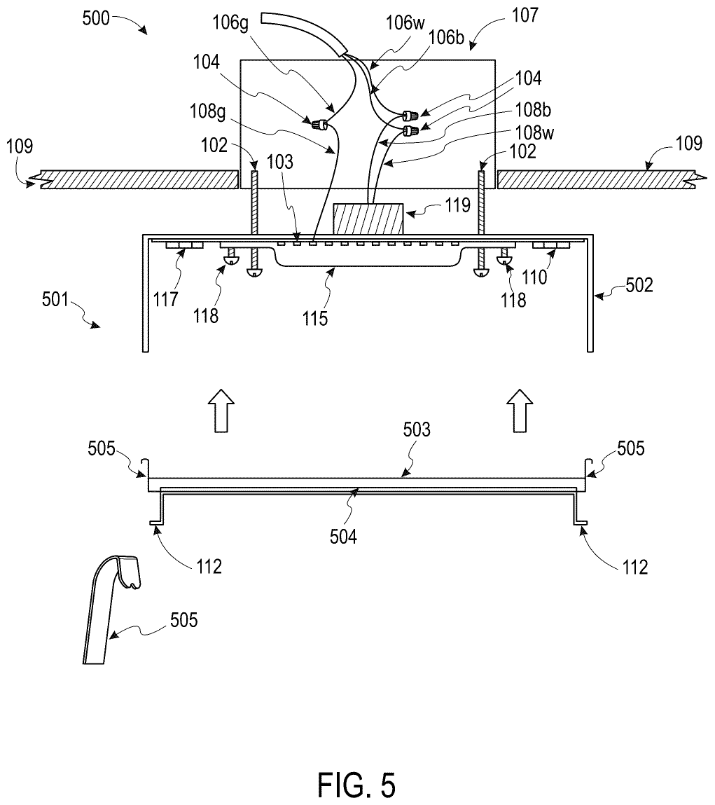

FIG. 4A illustrates a view 400A of a recessed luminaire with a hinged trim and a removeable junction box, attached to a ceiling using new construction spring clips, in accordance with at least one embodiment. FIG. 4A depicts an LED printed circuit board assembly (PCBA) 103, a plurality of wire connectors 104, a building's electrical wires 106b, 106g, & 106w, a driver's input wires 108b, & 108w, a building's wall or ceiling material 109, a switch (SWAT) 110, a housing closing element 111a, a trim closing element 111b, a finger pull 112, a luminaire trim 113, a diffuser lens 114, a protective cover 115, a hinge 116, a switch (SCCT) 117, a plurality of protective cover screws 118, an LED driver 119, a complete recessed luminaire 401, junction box output wires 402, a removable junction box 403, a plurality of new construction spring clips 404, a recessed luminaire housing 405, a junction box ground screw 406, a plurality of new construction clip attachment screws 407, a male wire connector 409, a female wire connector 410, a luminaire lip 412, and one or a plurality of junction box knock out holes 413, FIG. 4B illustrates a view 400B of a recessed luminaire with a hinged trim and a fixed junction box, to attach to a ceiling using new construction spring clips, in accordance with at least one embodiment. FIG. 4B depicts an LED printed circuit board assembly (PCBA) 103, a plurality of wire connectors 104, a building's electrical wires 106b, 106g, & 106w, a driver's input 108b & 108w, a building's wall or ceiling material 109, a switch (SWAT) 110, a housing closing element 111a, a trim closing element 111b, a finger pull 112, a luminaire trim 113, a diffuser lens 114, a protective cover 115, a hinge 116, a switch (SCCT) 117, a plurality of protective cover screws 118, an LED driver 119, a plurality of new construction spring clips 404, a recessed luminaire housing 405, a junction box ground screw 406, a plurality of new construction clip attachment screws 407, an attached junction box 408, a luminaire lip 412, one or a plurality of junction box knock out holes 413, and a complete recessed luminaire 414, FIG. 5 illustrates a view 500 of a flush mount luminaire with a friction fit trim to attach to a building's electrical box, in accordance with at least one embodiment. FIG. 5 depicts a plurality of junction box mounting screws 102, an LED printed circuit board assembly (PCBA) 103, a plurality of wire connectors 104, a building's electrical wires 106b, 106g & 106w, a building's electrical junction box 107, a luminaire's input wire's 108b, 108g & 108w, wall or ceiling material 109, a switch (SWAT) 110, a plurality of finger pulls 112, a protective cover 115, a switch (SCCT) 117, a plurality of protective cover screws 118, an LED driver 119, a complete flush mount luminaire 501, a flush mount luminaire housing 502, a flush mount luminaire trim 503, a diffuser lens 504, and a plurality of friction clips 505.

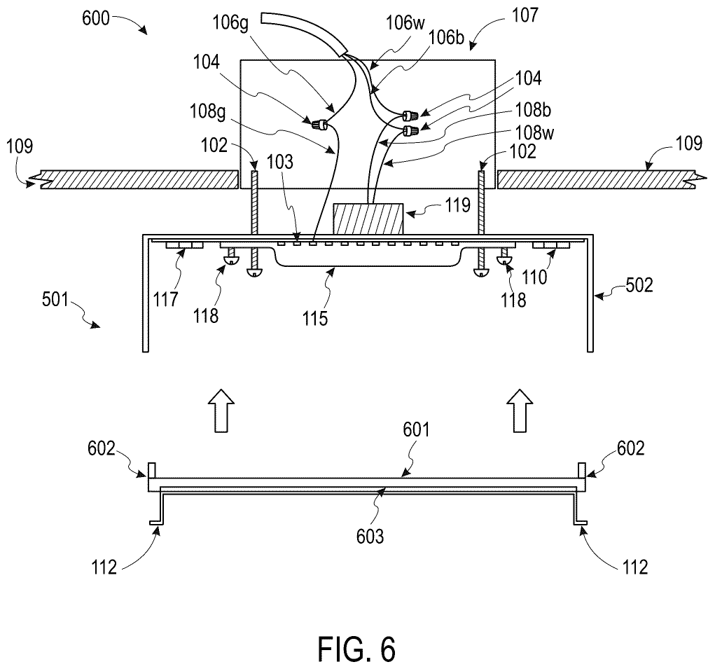

FIG. 6 illustrates a view 600 of a flush mount luminaire with a magnetic trim to attach to a building's electrical box, in accordance with at least one embodiment. FIG. 6 depicts a plurality of junction box mounting screws 102, an LED printed circuit board assembly (PCBA) 103, a plurality of wire connectors 104, a building's electrical wires 106b, 106g & 106w, a building's electrical junction box 107, a luminaire's input wire's 108b, 108g & 108w, wall or ceiling material 109, a switch (SWAT) 110, a plurality of finger pull 112, a protective cover 115, a switch (SCCT) 117, a plurality of protective cover screws 118, an LED driver 119, a complete recessed luminaire 501, a luminaire body 502, a luminaire trim 601, a plurality of magnets 602, and a diffuser lens 603.

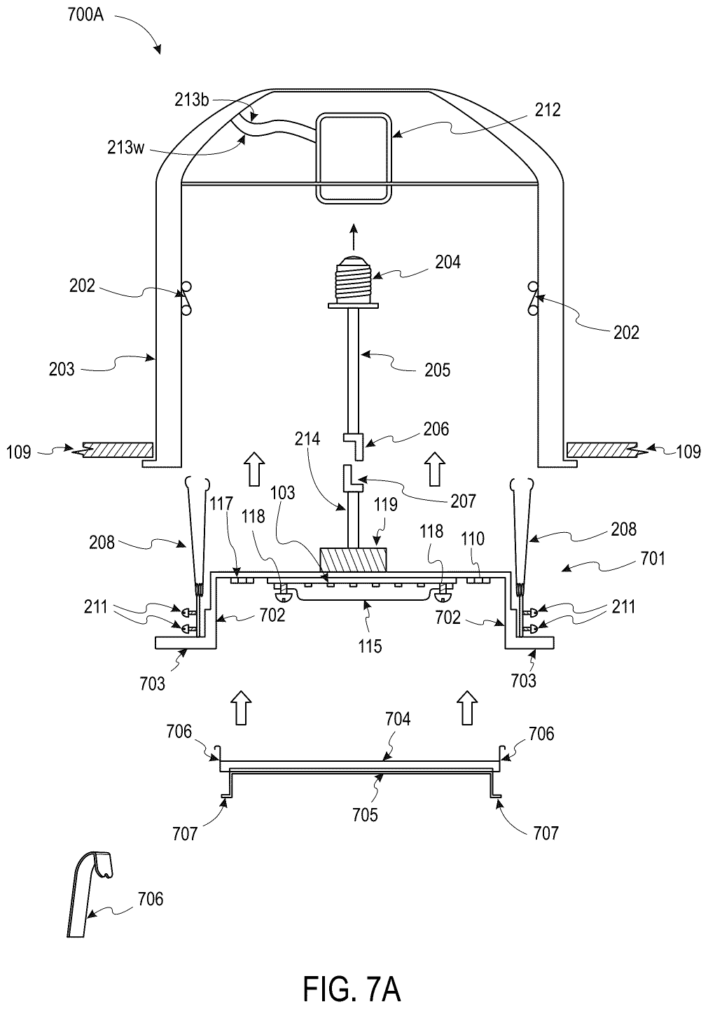

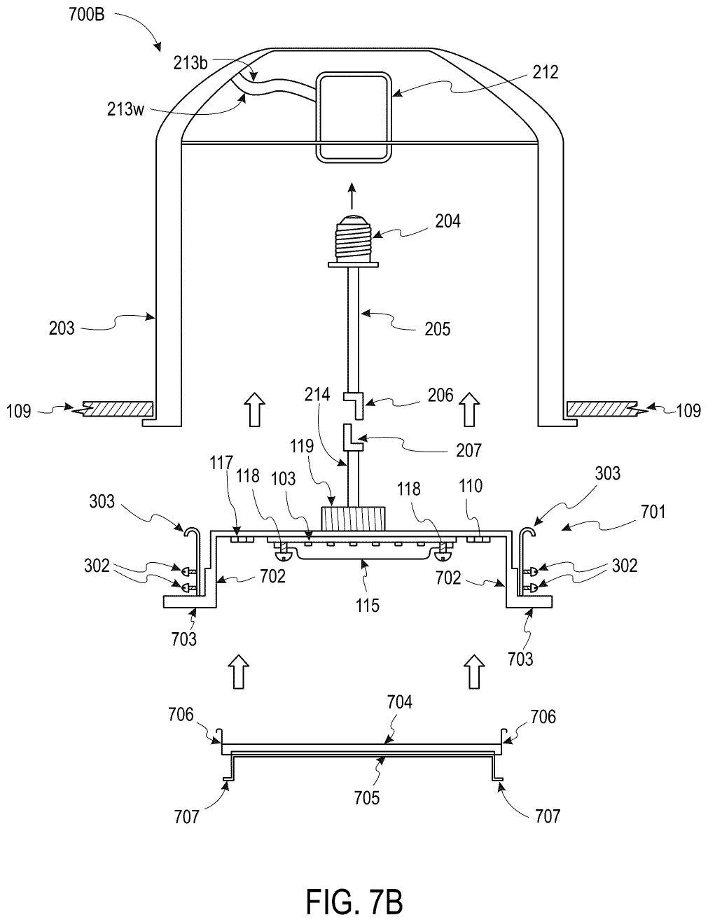

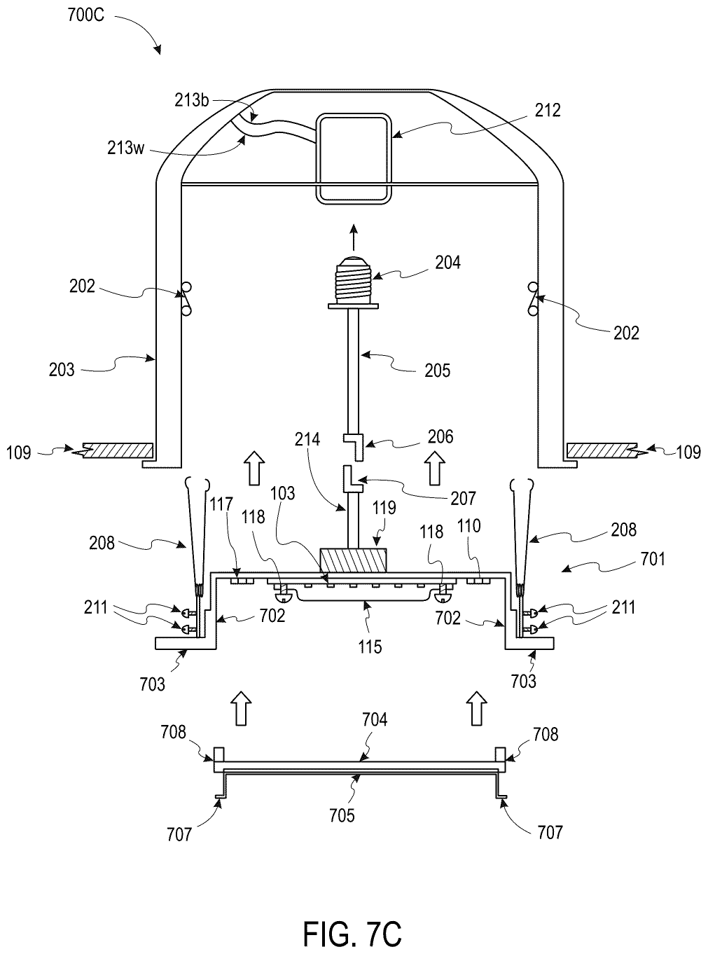

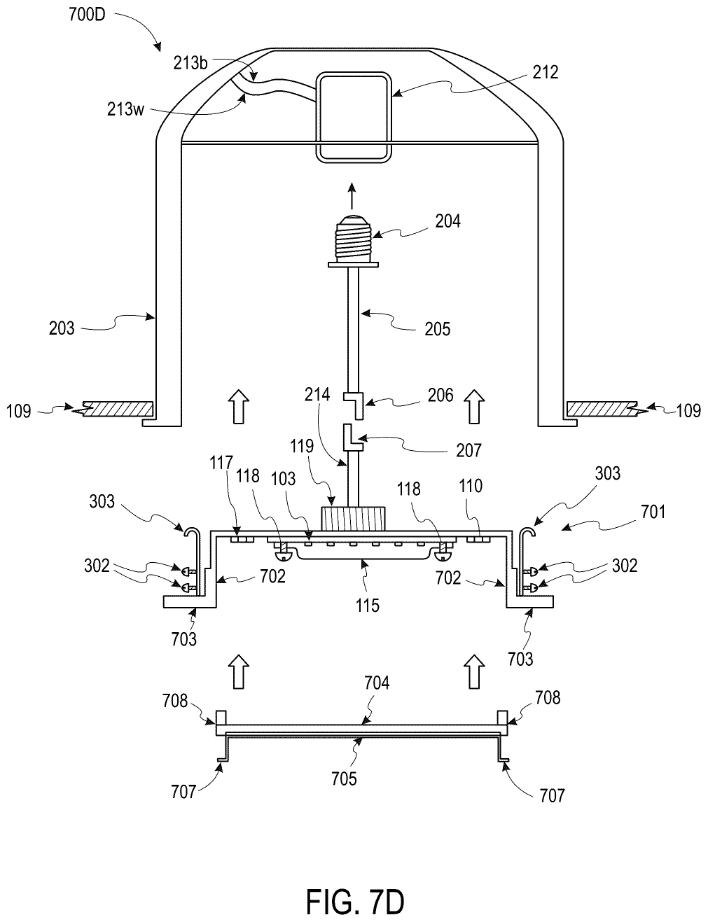

FIG. 7A illustrates a view 700A of a recessed luminaire with a friction fit trim to attach to a recessed lighting fixture housing using torsion spring retrofit clips, in accordance with at least one embodiment. FIG. 7A depicts an LED printed circuit board assembly (PCBA) 103, wall or ceiling material 109, a switch (SWAT) 110, a protective cover 115, a switch (SCCT) 117, a plurality of protective cover screws 118, an LED driver 119, a plurality of receptacle tabs attached to the inside of a recessed lighting fixture's housing 202, a recessed lighting fixture housing 203, a socket adapter 204, socket adapter output wires 205, a male luminaire disconnect 206, a female luminaire disconnect 207, a plurality of torsion spring retrofit clips 208, a plurality of torsion spring attachment screws 211, a lamp holder 212, a recessed lighting fixture's output electrical wires 213b & 213w, a driver input wires 214, a complete luminaire 701, a luminaire body 702, a luminaire lip 703, a luminaire trim 704, a diffuser lens 705, a plurality of friction fit clips attached to the luminaire trim 706, and a plurality of finger pulls 707.

FIG. 7B illustrates a view 700B of a recessed luminaire with a friction fit trim to attach to a recessed lighting fixture housing using friction fit retrofit clips, in accordance with at least one embodiment. FIG. 7B depicts an LED printed circuit board assembly (PCBA) 103, wall or ceiling material 109, a switch (SWAT) 110, a protective cover 115, a switch (SCCT) 117, a plurality of protective cover screws 118, an LED driver 119, a recessed lighting fixture housing 203, a socket adapter 204, socket adapter output wires 205, a male luminaire disconnect 206, a female luminaire disconnect 207, a lamp holder 212, a recessed lighting fixture's output electrical wires 213b & 213w, a driver input wires 214, a plurality of friction fit retrofit clips 303, a plurality of friction fit retrofit clip attachment screws 302, a complete luminaire 701, a luminaire body 702, a luminaire lip 703, a luminaire trim 704, a diffuser lens 705, a plurality of friction fit clips attached to the luminaire trim 706, and a plurality of finger pulls 707.

FIG. 7C illustrates a view 700C of a recessed luminaire with a magnetic trim to attach to a recessed lighting fixture housing using torsion spring retrofit clips, in accordance with at least one embodiment. FIG. 7C depicts an LED printed circuit board assembly (PCBA) 103, wall or ceiling material 109, a switch (SWAT) 110, a protective cover 115, a switch (SCCT) 117, a plurality of protective cover screws 118, an LED driver 119, a plurality of receptacle tabs attached to the inside of a recessed lighting fixture's housing 202, a recessed lighting fixture housing 203, a socket adapter 204, socket adapter output wires 205, a male luminaire disconnect 206, a female luminaire disconnect 207, a plurality of torsion spring retrofit clips 208, a plurality of torsion spring attachment screws 211, a lamp holder 212, a recessed lighting fixture's output electrical wires 213b & 213w, a driver input wires 214, a complete luminaire 701, a luminaire body 702, a luminaire lip 703, a luminaire trim 704, a diffuser lens 705, a plurality of finger pulls 707, and a plurality of magnets 708, FIG. 7D illustrates a view 700D of a recessed luminaire with a magnetic trim to attach to a recessed lighting fixture housing using friction fit retrofit clips, in accordance with at least one embodiment. FIG. 7D depicts an LED printed circuit board assembly (PCBA) 103, wall or ceiling material 109, a switch (SWAT) 110, a protective cover 115, a switch (SCCT) 117, a plurality of protective cover screws 118, an LED driver 119, a recessed lighting fixture housing 203, a socket adapter 204, socket adapter output wires 205, a male luminaire disconnect 206, a female luminaire disconnect 207, a lamp holder 212, a recessed lighting fixture's output electrical wires 213b & 213w, a driver input wires 214, a plurality of friction fit retrofit clips 303, a plurality of friction fit retrofit clip attachment screws 302, a complete luminaire 701, a luminaire body 702, a luminaire lip 703, a luminaire trim 704, a diffuser lens 705, a plurality of finger pulls 707, and a plurality of magnets 708.

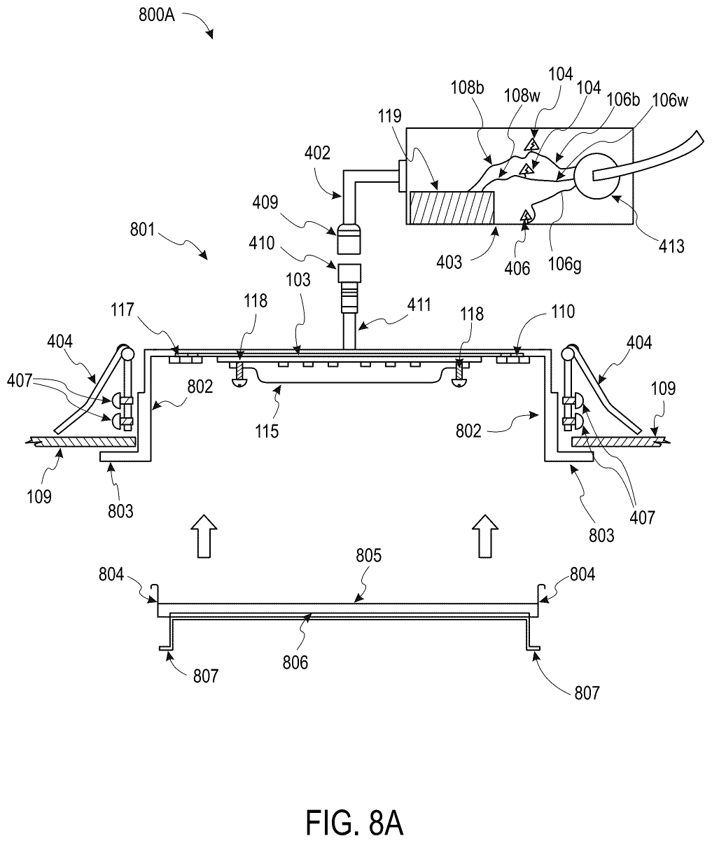

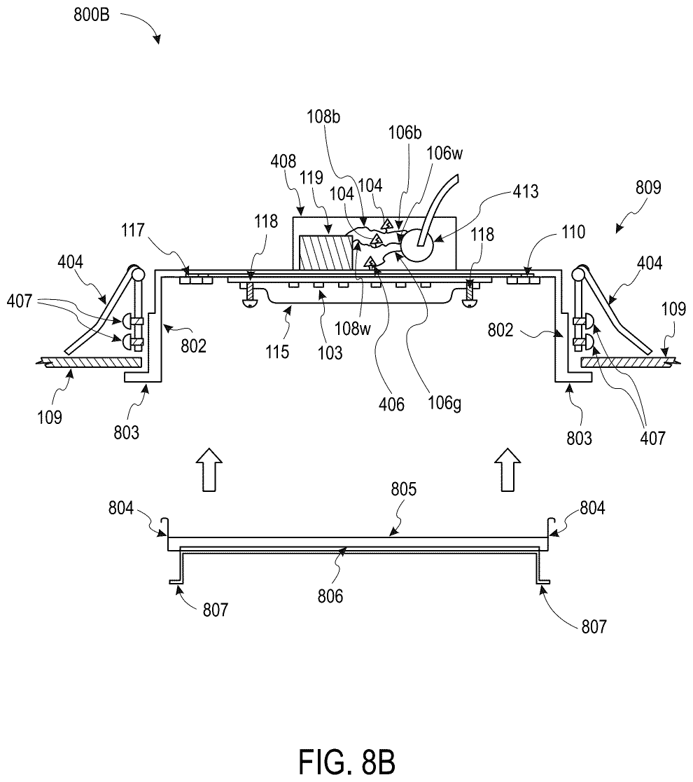

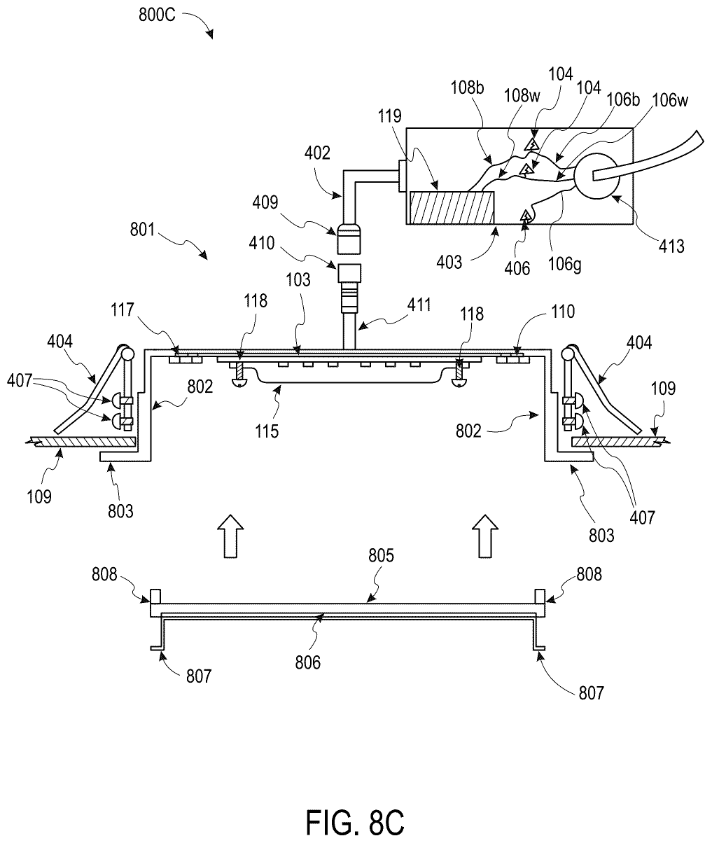

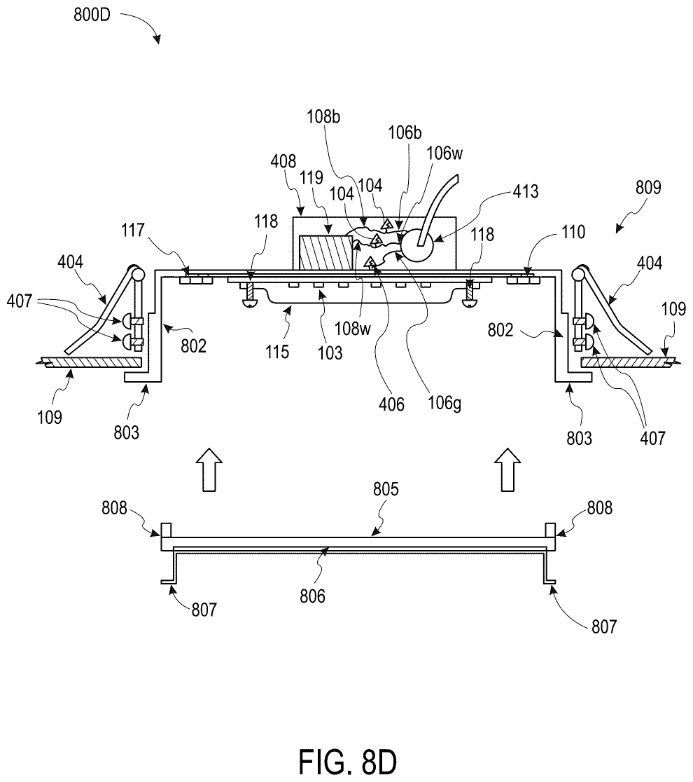

FIG. 8A illustrates a view 800A of a recessed luminaire with a friction fit trim and a removeable junction box, to attach to a ceiling using new construction spring clips, in accordance with at least one embodiment. FIG. 8A depicts an LED printed circuit board assembly (PCBA) 103, a plurality of wire connectors 104, a building's electrical wires 106b, 106g & 106w, a driver's input wires 108b & 108w, a building's wall or ceiling material 109, a switch (SWAT) 110, a protective cover 115, a switch (SCCT) 117, a plurality of protective cover screws 118, an LED driver 119, junction box output wires 402, a removable junction box 403, a plurality of new construction spring clips 404, a junction box ground screw 406, a plurality of new construction clip attachment screws 407, a male wire connector 409, a female wire connector 410, luminaire input wires 411, one or a plurality of junction box knock out holes 413, a complete recessed luminaire 801, a recessed luminaire body 802, a recessed luminaire lip 803, a plurality of friction fit clips attached to the recessed luminaire trim 804, a recessed luminaire trim 805, a recessed luminaire diffuser lens 806, and a plurality of finger pulls attached to the recessed luminaire trim 807.

FIG. 8B illustrates a view 800B of a recessed luminaire with a friction fit trim and a fixed junction box, to attach to a ceiling using new construction spring clips, in accordance with at least one embodiment. FIG. 8B depicts an LED printed circuit board assembly (PCBA) 103, a plurality of wire connectors 104, a building's electrical wires 106b, 106g & 106w, a driver's input wires 108b & 108w, a building's wall or ceiling material 109, a switch (SWAT) 110, a protective cover 115, a switch (SCCT) 117, a plurality of protective cover screws 118, an LED driver 119, a plurality of new construction spring clips 404, a junction box ground screw 406, a plurality of new construction clip attachment screws 407, a fixed junction box 408, one or a plurality of junction box knock out holes 413, a recessed luminaire body 802, a recessed luminaire lip 803, a plurality of friction fit clips 804, a recessed luminaire trim 805, a recessed luminaire diffuser lens 806, a plurality of finger pulls 807, and a complete recessed luminaire 809.

FIG. 8C illustrates a view 800C of a recessed luminaire with a magnetic trim and a removeable junction box, to attach to a ceiling using new construction spring clips, in accordance with at least one embodiment. FIG. 8C depicts an LED printed circuit board assembly (PCBA) 103, a plurality of wire connectors 104, a building's electrical wires 106b, 106g & 106w, a driver's input wires 108b & 108w, a building's wall or ceiling material 109, a switch (SWAT) 110, a protective cover 115, a switch (SCCT) 117, a plurality of protective cover screws 118, an LED driver 119, junction box output wires 402, a removable junction box 403, a plurality of new construction spring clips 404, a junction box ground screw 406, a plurality of new construction clip attachment screws 407, a male wire connector 409, a female wire connector 410, one or a plurality of junction box knock out holes 413, a complete recessed luminaire 801, a recessed luminaire body 802, a recessed luminaire lip 803, a recessed luminaire trim 805, a recessed luminaire diffuser lens 806, a plurality of trim finger pulls 807, and a plurality of magnets 808.

8D illustrates a view 800D of a recessed luminaire with a magnetic trim and a fixed junction box, to attach to a ceiling using new construction spring clips, in accordance with at least one embodiment. FIG. 8D depicts an LED printed circuit board assembly (PCBA) 103, a plurality of wire connectors 104, a building's electrical wires 106b, 106g, & 106w, a driver's input wires 108b & 108w, a building's wall or ceiling material 109, a switch (SWAT) 110, a protective cover 115, a switch (SCCT) 117, a plurality of protective cover screws 118, an LED driver 119, a plurality of new construction spring clips 404, a junction box ground screw 406, a plurality of new construction clip attachment screws 407, an attached junction box 408, one or a plurality of junction box knock out holes 413, a recessed luminaire body 802, a recessed luminaire lip 803, a recessed luminaire trim 805, a recessed luminaire diffuser lens 806, a plurality of trim finger pulls 807, a plurality of magnets 808, and a complete recessed luminaire 809.

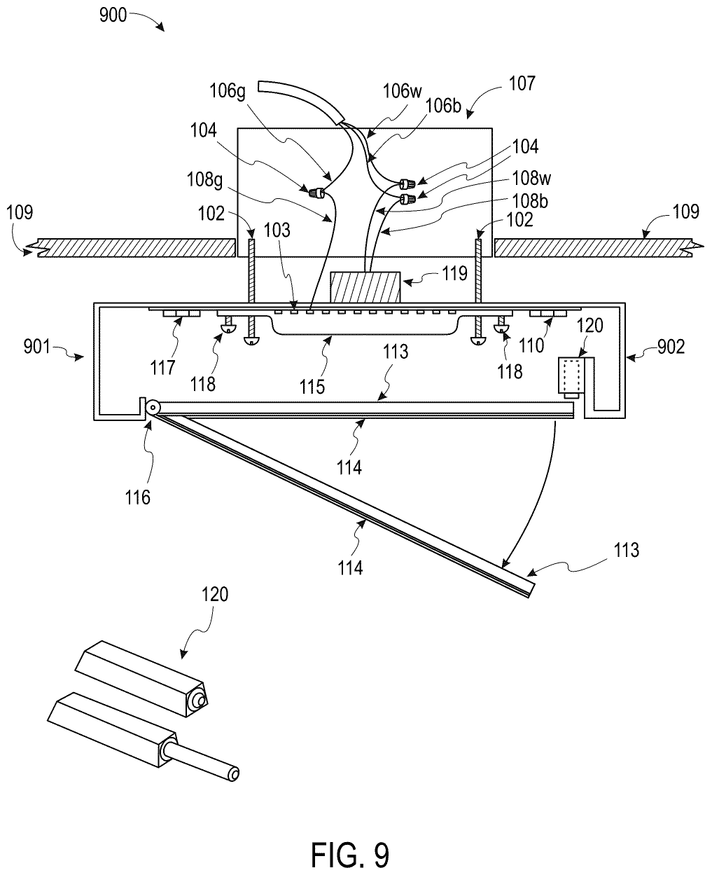

FIG. 9 illustrates a view 900 of a flush mount luminaire with a hinged trim to attach to a building's electrical box, in accordance with at least one embodiment. FIG. 9 depicts a complete flush mount luminaire 101, a plurality of junction box mounting screws 102, an LED printed circuit board assembly (PCBA) 103, a plurality of wire connectors 104, a luminaire housing 105, a building's power wires 106b & 106g & 106w, a building's electrical junction box 107, a luminaire's input wire's 108b & 108g & 108w, wall or ceiling material 109, a switch (SWAT) 110, a luminaire trim 113, a diffuser lens 114, a protective cover 115, a hinge 116, a switch (SCCT) 117, a plurality of protective cover screws 118, an LED driver 119, a push to open mechanism 120, a complete luminaire 901, and a luminaire body 902.

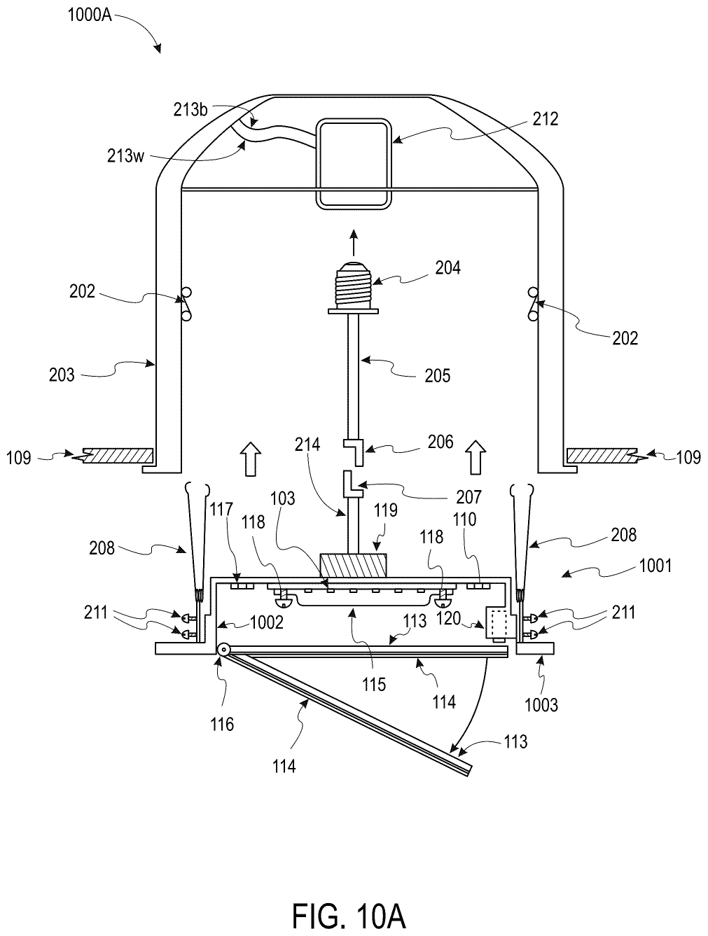

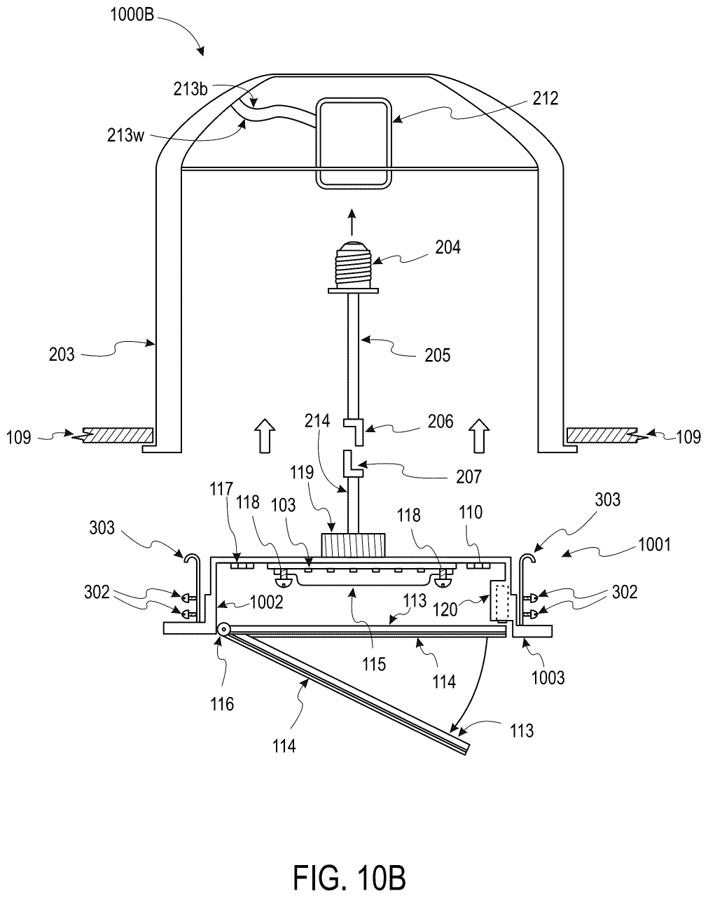

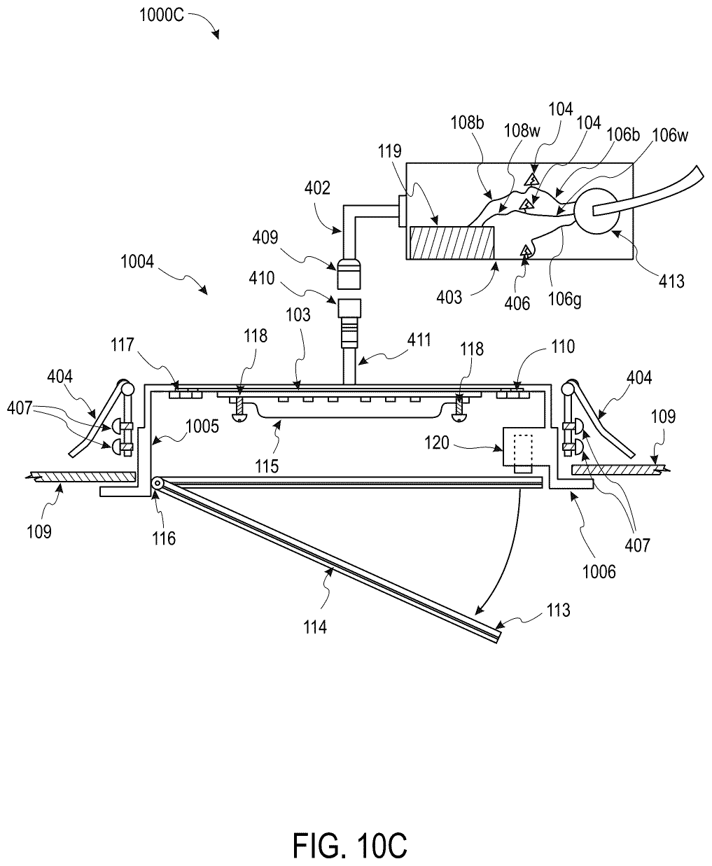

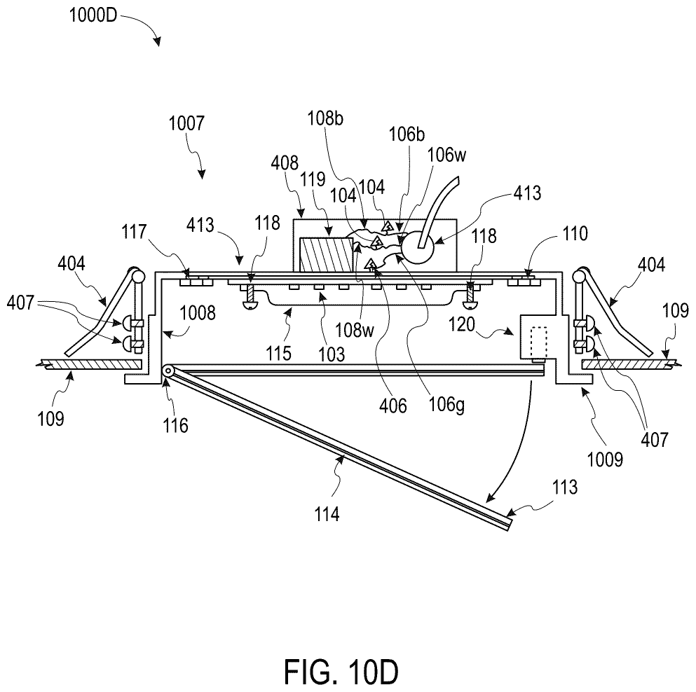

FIG. 10A illustrates a view 1000A of a recessed luminaire with a hinged trim to attach to a recessed lighting fixture housing using torsion spring retrofit clips, in accordance with at least one embodiment. FIG. 10A depicts an LED printed circuit board assembly (PCBA) 103, wall or ceiling material 109, a switch (SWAT) 110, a luminaire trim 113, a diffuser lens 114, a protective cover 115, a hinge 116, a switch (SCCT) 117, a plurality of protective cover screws 118, an LED driver 119, a push to open mechanism 120, a plurality of receptacle tabs attached to the inside of a recessed lighting fixture's housing 202, a recessed lighting fixture housing 203, a socket adapter 204, socket adapter output wires 205, a male luminaire disconnect 206, a female luminaire disconnect 207, a plurality of torsion spring retrofit clips 208, a luminaire lip 209, a luminaire housing 210, a plurality of torsion spring attachment screws 211, a lamp holder 212, a recessed lighting fixture's output electrical wires 213b & 213w, an LED driver input wires 214, a complete luminaire 1001, a luminaire body 1002, and a luminaire lip 1003.

FIG. 10B illustrates a view 1000B of a recessed luminaire with a hinged trim to attach to a recessed lighting fixture housing using friction fit retrofit clips, in accordance with at least one embodiment. FIG. 10B depicts an LED printed circuit board assembly (PCBA) 103, wall or ceiling material 109, a switch (SWAT) 110, a luminaire trim 113, a diffuser lens 114, a protective cover 115, a hinge 116, a switch (SCCT) 117, a plurality of protective cover screws 118, an LED driver 119, a recessed lighting fixture housing 203, a socket adapter 204, socket adapter output wires 205, male luminaire disconnect 206, female luminaire disconnect 207, a luminaire lip 209, a luminaire housing 210, a lamp holder 212, a recessed lighting fixture's output electrical wires 213b & 213w, a plurality of friction fit retrofit clip attachment screws 302, a plurality of friction fit retrofit clips 303, a complete luminaire 1001, a luminaire body 1002, and a luminaire lip 1003.

FIG. 10C illustrates a view 1000C of a recessed luminaire with a hinged trim and a removeable junction box, attached to a ceiling using new construction spring clips, in accordance with at least one embodiment. FIG. 10C depicts an LED printed circuit board assembly (PCBA) 103, a plurality of wire connectors 104, a building's electrical wires 106b, 106g, & 106w, a driver's input wires 108b, & 108w, a building's wall or ceiling material 109, a switch (SWAT) 110, a luminaire trim 113, a diffuser lens 114, a protective cover 115, a hinge 116, a switch (SCCT) 117, a plurality of protective cover screws 118, an LED driver 119, a push to open mechanism 120, junction box output wires 402, a removable junction box 403, a plurality of new construction spring clips 404, a recessed luminaire housing 405, a junction box ground screw 406, a plurality of new construction clip attachment screws 407, a male wire connector 409, a female wire connector 410, one or a plurality of junction box knock out holes 413, a complete luminaire 1004, a luminaire body 1005, and a luminaire lip 1006.

FIG. 10D illustrates a view 1000D of a recessed luminaire with a hinged trim and a fixed junction box, to attach to a ceiling using new construction spring clips, in accordance with at least one embodiment. FIG. 10D depicts an LED printed circuit board assembly (PCBA) 103, a plurality of wire connectors 104, a building's electrical wires 106b, 106g, & 106w, a driver's input 108b & 108w, a building's wall or ceiling material 109, a switch (SWAT) 110, a luminaire trim 113, a diffuser lens 114, a protective cover 115, a hinge 116, a switch (SCCT) 117, a plurality of protective cover screws 118, an LED driver 119, a push to open mechanism 120, a plurality of new construction spring clips 404, a recessed luminaire housing 405, a junction box ground screw 406, a plurality of new construction clip attachment screws 407, an attached junction box 408, a luminaire lip 412, one or a plurality of junction box knock out holes 413, a complete recessed luminaire 1007, a luminaire body 1008, and a luminaire lip 1009.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In some implementations, an LED luminaire is set forth as including a luminaire body configured to be mounted to a structural element, wherein the structural element includes a ceiling, a wall, a recessed lighting fixture housing, or an electrical junction box. The LED luminaire can further include a selectable switch positioned within the luminaire body. In some implementations, the selectable switch can include, but is not limited to, a wattage selection switch configured to modify power consumption characteristics and/or a correlated color temperature selection switch configured to modify light output characteristics. In some implementations, the LED luminaire can include an attachment mechanism configured to removably attach a luminaire trim to the luminaire body, wherein the attachment mechanism is configured to provide access to the user-selectable switch without requiring detachment of the luminaire body from the structural element, and wherein the attachment mechanism comprises at least one of: a hinge that attaches the luminaire trim to the luminaire body, a friction fit clip that removably attaches the luminaire trim to the luminaire body, or a magnet that removably attaches the luminaire trim to the luminaire body.

In some implementations, the hinge is configured to allow the luminaire trim to pivot away from the luminaire body while remaining connected to the luminaire body, thereby providing access to the user-selectable switch. In some implementations, the friction fit clip is configured to allow the luminaire trim to be temporarily detached from the luminaire body and, subsequently, reattached to the luminaire body, thereby providing access to the user-selectable configuration switches. In some implementations, the magnet is configured to allow the luminaire trim to be temporarily detached from the luminaire body and subsequently reattached to the luminaire body, thereby providing access to the user-selectable configuration switches.

In some implementations, the LED luminaire can further include a finger pull attached to the luminaire trim that facilitates user manipulation of the attachment mechanism. In some implementations, the LED luminaire can include a push-to-open mechanism that facilitates user manipulation of the attachment mechanism. In some implementations, the user-selectable switch is positioned in an area of the luminaire body that is accessible to a user when the luminaire trim is manipulated via the attachment mechanism. In some implementations, the LED luminaire can include a protective cover positioned over the user-selectable switch, wherein the protective cover includes visual indications of switch settings.

In other implementations, an apparatus is set forth as including one or more light sources; one or more switches that control an output of the one or more light sources; a luminaire body that houses the one or more light sources and the one or more switches; a luminaire trim that at least partially covers the one or more light sources and the one or more switches being housed within the luminaire body; an attachment mechanism that is configured to provide access to the one or more switches without requiring detachment of the luminaire body from a structural element. In some implementations, the structure element includes at least one of a ceiling, a wall, a recessed lighting fixture housing, or an electrical junction box.

In some implementations, when the luminaire trim and attachment mechanism are in a closed arrangement relative to the luminaire body, the attachment mechanism positions the luminaire trim to cover the one or more switches and the one or more light sources. In some implementations, when the luminaire trim and attachment mechanism are in an opened or removed arrangement relative to the luminaire body, the attachment mechanism facilitates rearrangement of the luminaire trim to uncover the one or more switches without requiring detachment of the luminaire body from a structural element.

In some implementations, the attachment mechanism is configured such that a pulling force exerted, by a user, causes the attachment mechanism to transition from the closed arrangement to the open arrangement without removing the luminaire body from the structural element. In some implementations, the attachment mechanism secures the luminaire trim to the luminaire body using one or more magnets, one or more friction fit clips, or one or more hinges.

In yet other implementations, an apparatus is set forth as including one or more light sources; one or more switches that control an output of the one or more light sources; a luminaire body that houses the one or more light sources and the one or more switches; a luminaire lens that at least partially covers the one or more light sources and the one or more switches being housed within the luminaire body; an attachment mechanism that is configured to provide access to the one or more switches without requiring detachment of the luminaire body from a structural element. In some implementations, the structure element includes at least one of a ceiling, a wall, a recessed lighting fixture housing, or an electrical junction box.

In some implementations, when the luminaire lens and attachment mechanism are in a closed arrangement relative to the luminaire body, the attachment mechanism positions the luminaire lens to cover the one or more switches and the one or more light sources. In some implementations, when the luminaire lens and attachment mechanism are in an opened or removed arrangement relative to the luminaire body, the attachment mechanism facilitates rearrangement of the luminaire lens to uncover the one or more switches without requiring detachment of the luminaire body from a structural element. In some implementations, the attachment mechanism is configured such that a pulling force exerted, by a user, causes the attachment mechanism to transition from the closed arrangement to the open arrangement without removing the luminaire body from the structural element. In some implementations, the attachment mechanism secures the luminaire lens to the luminaire body using one or more magnets, one or more friction fit clips, or one or more hinges.

What is claimed is:

1. An LED luminaire, comprising:
a luminaire body configured to be mounted to a structural element, wherein the structural element includes a ceiling, a wall, a recessed lighting fixture housing, or an electrical junction box;
a user-selectable switch positioned within the luminaire body, wherein the user-selectable switch includes at least one of:
a correlated color temperature selection switch configured to modify light Output characteristics, or
a wattage selection switch configured to modify power consumption characteristics;
an attachment mechanism configured to removably attach a luminaire trim to the luminaire body;
wherein the attachment mechanism is configured to provide access to the user-selectable switch without requiring detachment of the luminaire body from the structural element, and
wherein the attachment mechanism comprises at least one of:
a hinge that attaches the luminaire trim to the luminaire body,
a friction fit clip that removably attaches the luminaire trim to the luminaire body, or
a magnet that removably attaches the luminaire trim to the luminaire body.

2. The LED luminaire of claim 1, wherein the hinge is configured to allow the luminaire trim to pivot away from the luminaire body while remaining connected to the luminaire body, thereby providing access to the user-selectable switch.

3. The LED luminaire of claim 1, wherein the friction fit clip is configured to allow the luminaire trim to be temporarily detached from the luminaire body and, subsequently, reattached to the luminaire body, thereby providing access to the user-selectable configuration switches.

4. The LED luminaire of claim 1, wherein the magnet is configured to allow the luminaire trim to be temporarily detached from the luminaire body and subsequently reattached to the luminaire body, thereby providing access to the user-selectable configuration switches.

5. The LED luminaire of claim 1, further comprising:
a finger pull attached to the luminaire trim that facilitates user manipulation of the attachment mechanism.

6. The LED luminaire of claim 1, further comprising:
a push-to-open mechanism that facilitates user manipulation of the attachment mechanism.

7. The LED luminaire of claim 1, wherein the user-selectable switch is positioned in an area of the luminaire body that is accessible to a user when the luminaire trim is manipulated via the attachment mechanism.

8. The LED luminaire of claim 1, further comprising:
a protective cover positioned over the user-selectable switch, wherein the protective cover includes visual indications of switch settings.

9. An apparatus, comprising:
one or more light sources;
one or more switches that control an output of the one or more light sources;
a luminaire body that houses the one or more light sources and the one or more switches;
a luminaire trim that at least partially covers the one or more light sources and the one or more switches being housed within the luminaire body;
an attachment mechanism that is configured to provide access to the one or more switches without requiring detachment of the luminaire body from a structural element,
wherein the structure element includes at least one of a ceiling, a wall, a recessed lighting fixture housing, or an electrical junction box.

10. The apparatus of claim 9, wherein, when the luminaire trim and attachment mechanism are in a closed arrangement relative to the luminaire body, the attachment mechanism positions the luminaire trim to cover the one or more switches and the one or more light sources.

11. The apparatus of claim 10, wherein, when the luminaire trim and attachment mechanism are in an opened or removed arrangement relative to the luminaire body, the attachment mechanism facilitates rearrangement of the luminaire trim to uncover the one or more switches without requiring detachment of the luminaire body from a structural element.

13. The apparatus of claim 11, wherein the attachment mechanism is configured such that a pulling force exerted, by a user, causes the attachment mechanism to transition from the closed arrangement to the open arrangement without removing the luminaire body from the structural element.

12. The apparatus of claim 9, wherein the attachment mechanism secures the luminaire trim to the luminaire body using one or more magnets, one or more friction fit clips, or one or more hinges.

13. An apparatus, comprising:
one or more light sources;
one or more switches that control an output of the one or more light sources;
a luminaire body that houses the one or more light sources and the one or more switches;
a luminaire lens that at least partially covers the one or more light sources and the one or more switches being housed within the luminaire body;
an attachment mechanism that is configured to provide access to the one or more switches without requiring detachment of the luminaire body from a structural element,
wherein the structure element includes at least one of a ceiling, a wall, a recessed lighting fixture housing, or an electrical junction box.

14. The apparatus of claim 13, wherein, when the luminaire lens and attachment mechanism are in a closed arrangement relative to the luminaire body, the attachment mechanism positions the luminaire lens to cover the one or more switches and the one or more light sources.

15. The apparatus of claim 14, wherein, when the luminaire lens and attachment mechanism are in an opened or removed arrangement relative to the luminaire body, the attachment mechanism facilitates rearrangement of the luminaire lens to uncover the one or more switches without requiring detachment of the luminaire body from a structural element.

16. The apparatus of claim 15, wherein the attachment mechanism is configured such that a pulling force exerted, by a user, causes the attachment mechanism to transition from the closed arrangement to the open arrangement without removing the luminaire body from the structural element.

17. The apparatus of claim 13, wherein the attachment mechanism secures the luminaire lens to the luminaire body using one or more magnets, one or more friction fit clips, or one or more hinges.
